(19) United States
(12) Patent Application Publication
(10) Pub. No.: US 2014/0310977 A1
(43) Pub. Date: Oct. 23, 2014

(54) DRYING DEVICES

(71) Applicant: Direct Air Dryers Limited, Chertsey (GB)

(72) Inventors: Jack Bernard Elliott, Brighton (GB); David Kenneth Elliott, Strood Rochester (GB)

(73) Assignee: Direct Air Dryers Limited, Chertsey (GB)

(21) Appl. No.: 13/261,688

(22) PCT Filed: Jan. 9, 2012
(86) PCT No.: PCT/GB2012/000009

§ 371 Date: Jul. 11, 2013

(30) Foreign Application Priority Data
Jan. 13, 2011 (GB) 1100529.5

(51) Int. Cl. F26B 21/00

(52) U.S. Cl. CPC F26B 21/004
USPC 34/487; 34/239

(57) ABSTRACT

The present invention provides a drying device for a wall structure, the device comprising an inflatable drying mat (1) of lightweight plastic sheeting and generally comprising a floor engaging portion (2), a wall engaging portion (3), an outwardly facing portion (4) that extends between an outer edge portion (5) of the floor engaging portion (2) and an upper edge portion (6) of the wall engaging portion (3) to define a triangular cross-section when in use and connected to an air mover. The drying mat 1 also comprising opposite end portions (7, 8) that closes the mat (1) to form an inflatable configuration when in use. The floor engaging portion (2) and the wall engaging portion (3) are both provided with a multiplicity of apertures whereby, when the mat (1) is deployed against a wall structure and an air mover is attached to the mat (1) air passes through the multiplicity of apertures to dry the wall structure. The drying device also comprises at least one funnel-like apparatus (14) having a nozzle (16) whereby, when both sides of a wall structure are to be subjected to drying air from an air mover, the nozzle(s) (16) are inserted in pre-prepared apertures in the wall structure. In use of the drying device, a deflated mat (1) is laid on a floor and against a wall structure to be dried. The air mover is then powered up whereupon the mat (1) is deployed automatically against the wall to a height in excess of one metre without any outside assistance.

This invention is concerned with improvements in or relating to a drying device and is particularly concerned with improvements in or relating to a drying device for use in the drying out of walls of a building following the subjection of the walls to an excess of water during a flood or a deluge occasioned by burst pipes from above.

By drying device where used herein, it is meant a flexible mat that in use is laid against, or caused to lie against at least a first one metre portion of a wall as measured from the floor level.

When a building, which may be a dwelling, offices, shop premises or an industrial building, is flooded by an inrush of water or is subjected to a deluge from above, which may be caused by burst pipes or a leaking roof, it is most usual for the walls to be wetted above a level of more than one metre from the floor level of the wall.

However, when the floodwaters recede or the deluge from above is addressed, the water on or within a wall will rapidly find its own level due to gravity and or the porosity of the wall structure; thus, it is of paramount import that the wall is subjected to a drying treatment at the earliest possible time after the floodwaters recede or the deluge from above ceases.

Previous arrangements for drying out a wall have usually addressed the problem by attaching wall mats to the whole wall; this procedure is somewhat redundant in the light of the comments herein relating to the water level that remains in a wall after the floodwater has receded or deluge from above has stopped.

Thus, the present invention provides a more efficient and less costly way of drying out a wall, the present invention comprising a flexible mat of at least one metre in height when deployed, in use, against a wall, the flexible mat being configured in cross-section similarly to a retaining wall structure in that it comprises a floor engaging surface, a wall engaging surface and an outwardly facing surface that extends between an outer edge portion of the floor engaging surface and an upper edge portion of the wall engaging surface.

The flexible mat may conveniently comprise an attachment for directing air, heated or otherwise, into apertures provided in a wall against which the flexible mat is located.

More conveniently, the attachment may comprise a flexible tunnel-like apparatus having an open mouth portion at a upstream end thereof and a nozzle at an downstream end portion thereof, whereby, when the flexible mat is in use and air, heated or otherwise is provided from an air blower, may pass through the tunnel-like apparatus and through the nozzle into a space behind a wall that is being dried so that the wall is dried on each side thereof.

Preferably, the flexible tunnel-like apparatus may be attached to openings formed between the wall engaging portion and the floor-engaging portion of the mat.

Conveniently, both the tunnel-like apparatus and the flexible mat are provided with Velcro (RTM) covered edge portions that facilitate the mutual attachment one to the other.

There now follows by way of example of the invention, a detailed description, which is to be read with reference to the accompanying drawings in which:

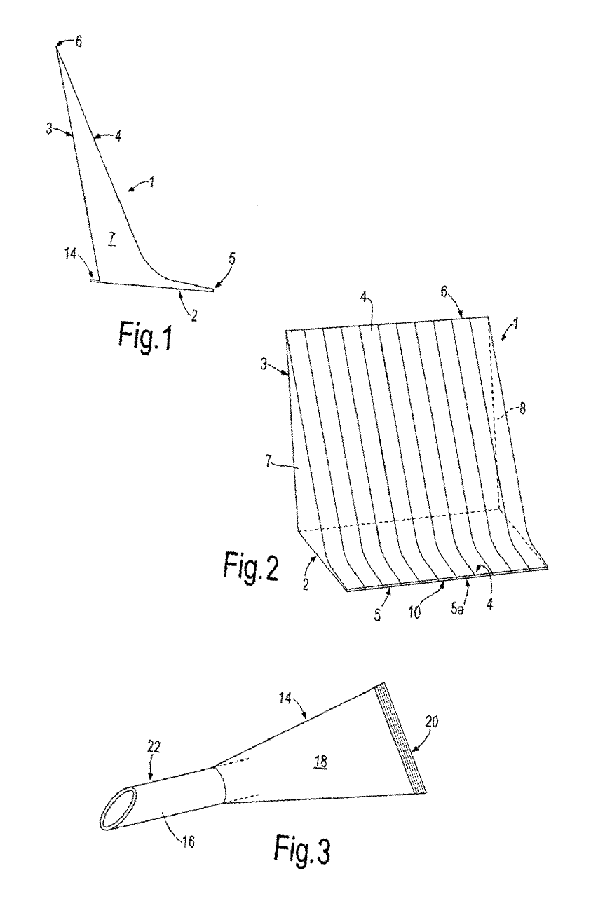

FIG. 1 shows a left hand end of a flexible mat of the invention as deployed when in use;

FIG. 2 is an upper perspective view showing hidden detail of the flexible mat; and,

FIG. 3 is an upper perspective view of an attachment for the flexible mat.

The present invention provides, see FIGS. 1 to 3, a flexible drying mat 1 made of lightweight plastic sheeting and generally comprising a floor engaging portion 2, a wall engaging portion 3, an outwardly facing portion 4 that extends between an outer edge portion 5 of the floor engaging portion 2 and an upper edge portion 6 of the wall engaging portion to define a triangular cross-section of similar configuration to that of a retaining wall structure.

The flexible drying mat 1 also comprises opposite end portions 7 and 8 that effectively close the flexible drying mat 1 to form an inflatable configuration when in use as will be explained in detail hereinafter.

The flexible drying mat 1 may be of any length commensurate with meeting the requirements for drying out a water-damaged wall. Several mats 1 may be arranged in end-to-end juxtaposition along a wall, not shown.

The flexible drying mat 1 further comprises a multiplicity of spaced apertures, not shown, in the floor engaging portion 2 and the wall engaging portion 3.

The outwardly facing portion 4 is connected to the floor engaging portion 2 and the wall engaging portion 3 by tag elements, not shown, of various lengths commensurate with attaining the desired wall engaging relationship when deployed against a wall. The tag elements, which are of any suitable material, are secured by stitching, or other suitable means, to inside surface of the floor engaging portion 2, the wall engaging portion 3 and the outwardly facing portion 4 respectively.

The flexible drying mat 1 is provided with a portion 10 between a mid portion 5a of the floor engaging portion 2 and a mid portion 4b of the outwardly facing portion 4, which portion 10 is closed by strips of Velcro (RTM), not shown.

When a mat 1 of the present invention is in use, an air mover, not shown, is connected to the mat 1 by opening the portion 10 and closing the Velcro strips onto like strips provided on the air mover.

Important features of the flexible drying mat are:
a) its lightweight structure and its flexibility that facilitates the collapsing of the mat 1 and enabling it to be rolled up for storage in a suitable container for transport;
b) the ease with which it may be deployed in use; and,
c) the effectiveness of the deployed mat in applying the drying air from an air mover directly onto the portion of a wall that retains the residue of floodwater thereby leading to a speedy and efficient remedy of the situation.

When a flexible drying mat 1 of the present invention is to be used in drying out a water damaged wall, an operative unpacks a mat 1 and unrolls the mat 1 to lie against the bottom of a wall, not shown. An air mover is connected to the mat 1 at the portion 10 by separating the Velcro strips, not shown, and closing the strips about like strips on a mouth of the air mover.

The air mover is powered with the result that air under pressure passes into the mat 1 causing the mat to be automatically deployed against a wall with no requirement for means for fixing the mat 1 to the wall.

Air from the air mover 12, heated or not, passes through the multiplicity of apertures in the floor engaging portion 2 and the wall engaging portion 3 to impinge upon a floor portion adjacent the wall and the wall up to a height of at least one metre from the floor

The present invention also includes a funnel-like apparatus 14 that is attached to the flexible mat 1 when it is required that the inside of a wall, not shown, is to be dried out concomitantly with the drying out of an outside of the wall.

To this end, the funnel-like apparatus 14 comprises a first portion 18 of flexible material having an upstream mouth portion 20 that is attached, in use, to an associated aperture, not shown, that is provided in the flexible mat 1 at a juncture of the floor engaging portion 2 and the wall engaging portion 3 thereof.

Both the mouth portion 20 and the aperture at said juncture of the portions 2 and 3 respectively, of the flexible mat 1, are provided with strips of Velcro (RTM) in order to facilitate the attachment of the apparatus 14 to the mat 1.

The funnel-like apparatus 14 is also provided with a nozzle 16 at a downstream portion 22 of the apparatus 14, which nozzle 16, when the mat 1 is in use and the inside of a wall is to be dried out concomitantly with the drying out of an outside of the wall, is inserted in a prepared aperture (not shown) that extends through the wall.

Thus upon powering up of an air mover connected to the mat 1, heated air, or air at ambient temperature, is caused to flow through the multiplicity of apertures in the wall engaging portion 3 and through the funnel-like apparatus 14 to impinge on the outside and inside of the wall respectively.

It has been found that the flexible drying mat 1 of the present invention, if used within a short period of time from the incidence of damage by floodwater or from a deluge from above caused by burst pipes, the advantages are that:
(i) there is no requirement to strip out the wall plaster or other surface facade;
(ii) the incidence of spoor growth is avoided;
(iii) the wall is dried in a faster time than hitherto possible by current methods and appliances;
(iv) the building is returned to the owners for use with a minimum of delay;
(v) there is no requirement to affix the novel drying mat to a wall surface unlike the pre-requisite that prior devices need to be affixed to a wall when in use; and,
(vi) because of the nature of the novel drying mat, in that no fixings are required when it is used, the use of the mat is non-invasive, except for apertures provided for acceptance of the nozzles 16 of the funnel-like apparatus 14, resulting in no undue damage to a main surface of the wall against which it is used.

It is to be appreciated that modifications may be made within the scope of the invention described herein; for example, the lightweight plastic sheeting of the flexible mat 1 may be replaced by any suitable material commensurate with achieving the quick rehabilitation of a flood damaged building.

Likewise, the funnel-like apparatus may be made from any flexible material, for example, fabric, thin gauge plastic, rubber or the like materials commensurate with ensuring the effective drying operation of the mat 1.

The nozzle 16 may also be made of any suitable materials, for example, plastic, metal or a moulded composite commensurate with ensuring the durability of the nozzle 16.

1. A drying device for drying a wall structure, the device comprising a floor engaging portion, a wall engaging portion, an outwardly facing portion that extends between an outer edge portion of the floor engaging portion and an upper edge portion of the wall engaging portion to define, in use, a triangular cross section.

2. A drying device according to claim 1, characterised in that the device also comprises opposite end portions that effectively close the drying device to form an inflatable configuration when in use.

3. A drying device according to claim 1, characterised in that the outwardly facing portion of the drying mat is connected internally to the floor engaging portion and the wall engaging portion by tag elements of various lengths commensurate with attaining the desired wall engaging relationship when the drying device is in use.

4. A drying device according to claim 3, characterised in that the tag elements, which are of any suitable material, are secured by stitching, or other suitable means, to inside surfaces of the floor engaging portion, the wall engaging portion and the outwardly facing portion respectively.

5. A drying device according to claim 1, characterised in that the drying device is provided with attachment means for an air mover, when the drying device is in use, said attachment means comprising inter-engaging portions of the outwardly facing portion and the floor engaging portions respectively.

6. A drying device according to claim 5, characterised in that the inter-engaging portions of the outwardly facing portion and the floor engaging portion comprise oppositely facing ‘Velcro’ strips, which in use are separated to facilitate the attachment of an air mover that is provided with ‘Velcro’ strips that are arranged in mutual engagement with the strips of the outwardly facing portion and the floor engaging portion.

7. A drying device according to claim 1, characterised in that the floor engaging portion and the wall engaging portion are provided with a plurality of apertures for directing air from an air mover against a floor and a wall structure to be dried when the drying device is in use.

8. A drying device according to claim 1, characterised in that the device is formed from flexible plastic sheeting or other flexible materials.

9. A drying device according to claim 1, characterised in that the device also comprises at least one funnel-like apparatus that is attached to the drying device for drying, when the device is in use, an inside surface of a wall structure.

10. A drying device according to claim 9, characterised in that each funnel-like apparatus comprises a first portion of flexible material having a mouth portion that is attached, in use, to an associated aperture provided in the drying device at a juncture of the floor engaging portion and the wall engaging portion thereof.

11. A drying device according to claim 10, characterised in that the funnel-like apparatus also comprises a nozzle at a downstream portion of the funnel-like apparatus, which nozzle, when in use, is inserted in a prepared aperture of the wall structure so that both sides of a wall structure may be subjected to air from an air mover, when the drying device is in use.

12. A method of drying a wall structure using a drying device according to claim 1, characterised in that the method comprises the steps of:
a) laying a drying device on a floor with a forward portion adjacent the wall structure;
b) attaching an air mover to an outer edge portion of the drying device; and,
c) powering the air mover to cause air under pressure to pass into the drying device whereby the drying device is caused to be automatically deployed against the wall structure without additional involvement of an operative.
